(19) United States
(12) Patent Application Publication
(10) Pub. No.: US 2024/0198283 A1
(43) Pub. Date: Jun. 20, 2024

(54) AN AIR TREATMENT ELEMENT, AN AIR TREATMENT UNIT AND A METHOD FOR PRODUCING THE AIR TREATMENT ELEMENT

(71) Applicant: MUNTERS EUROPE AKTIEBOLAG, Kista (SE)

(72) Inventors: Robert Arnell, Orsundsbro (SE); Daniel Preston, North Andover, MA (US); Ryan Milotte, Haverhill, MA (US)

(21) Appl. No.: 18/557,451

(22) PCT Filed: Apr. 20, 2022
(86) PCT No.: PCT/EP2022/060386

§ 371 Date: Oct. 26, 2023

(30) Foreign Application Priority Data
Apr. 27, 2021 (SE) 2150531-8

(51) Int. Cl. B01D 53/26; B01D 53/06; B01J 20/32; B33Y 10/00; B33Y 50/02; B33Y 80/00; F24F 1/0083

(52) U.S. Cl. CPC B01D 53/261; B01D 53/06; B01J 20/32; B33Y 10/00; B33Y 50/02; B33Y 80/00; F24F 1/0083; B01D 2257/504; B01D 2257/708; B01D 2257/80; B01D 2258/06

(57) ABSTRACT

The invention relates to an air treatment element (1) for an air treatment unit (2), the air treatment element (1) comprising: a drum shaped rotor element (4), provided with a rotational axis (6); a first end surface (8) of the rotor element (4) having a first normal (N1), which is parallel to the rotational axis (6); a second end surface (10) of the rotor element (4) having a second normal (N2), which is parallel to the rotational axis (6); and a plurality of channels (12), which are disposed parallel to the rotational axis (6), and which channels (12) extend continuous from the first to the second end surface (8, 10) of the rotor element (4); wherein the air treatment element (1) further comprises: at least one air treatment substance (14, 18) arranged on walls (16) of the continuous channels (12), wherein the content of the at least one air treatment substance (14, 18) is arranged to increase or decrease in a direction from the first end surface (8) to the second end surface (10).

### TECHNICAL FIELD

The present disclosure relates to an air treatment element, an air treatment unit and a method, performed by a control device, for producing the air treatment element.

### BACKGROUND ART

Dehumidifiers, such as sorption dehumidifiers and condensate dehumidifiers, are used for separating and removing moisture from air. A sorption dehumidifier typically comprises a dehumidifying element in the form of a wheel or rotor holding desiccant material, which is effective in attracting and retaining water vapour. The desiccant rotor may be divided in two sections, a process section and a regeneration section. The airflow to be dehumidified, process air, will pass through the process section of the desiccant rotor, the desiccant material in the rotor extracts moisture from the process air, so that it can leave the rotor as dried air. Simultaneously, the desiccant material is regenerated by another air stream, which flows through the regeneration section, all the while the desiccant rotor may rotate slowly about its longitudinal axis. By means of the simultaneous dehumidification of the process air and regeneration of desiccant material, the dehumidifier can be operated continuously. US2007056307 discloses an example of a dehumidifier having a desiccant wheel.

In addition to separating and removing moisture from air, there is an interest in separating other substances from air.

Document U.S. Pat. No. 5,771,707 A discloses a unitary heat exchanger device produced from a sheet component comprising a flat sheet member and a corrugated sheet member attached to the flat sheet member. A first area is coated with a desiccant coating for attracting water vapour and a second area is free from coating and may be able to absorb and release heat to air. Document EP0492879 B1 discloses a gas adsorbing element to adsorb and remove different kinds or organic solvent vapors and/or odor components mixed and contained in air. A first area may be coated with a zeolite and another area with active carbon.

Known dehumidifying elements, such as wheels or rotors holding desiccant material, are traditionally produced, with corrugation and dipping and/or waterfall processes.

### SUMMARY OF THE INVENTION

The known production processes provide limited control in how much sorbent is attached to the carrier material (typically a fiber veil) during dipping/waterfall impregnation. Furthermore they set some limitations for which geometries and flute heights that can be practically produced without causing blocked flutes or ability to actually coat the flute surfaces, and do not support the creation of gradient materials to utilize the components in a more cost efficient way and to increase the air treatment performance. Also, the known production methods do not allow the flexibility to alter the material properties in the rotors unless the whole bath or waterfall lines are changed. Typically, this can only be carried out between batches, require cumbersome mixing and tuning of the bath's chemical concentrations and temperatures. One known approach is to achieve stepwise composition changes in sorbent media is to stack several media types on top of each other when assembling the rotor. This causes discontinuities of the channels through the rotor, which may lead to internal leakage between the layers and poor separation performance. Thus, despite known solutions in the field, it would be desirable to develop an air treatment element, which overcomes or alleviates at least some of the drawbacks of the prior art.

An objective of the present invention is to achieve an air treatment element, in which allows for a stable, reliable and effective treatment of air, and thereby improves the functionality/performance of an air handling unit.

A further objective of the present invention is to achieve a method producing an air treatment element, which facilitates the production of air treatment element of different characteristics.

A further objective of the present invention is to achieve a method for producing an air treatment element, which allows for flexibility to alter the material properties in the treatment element.

These objectives are achieved with the above-mentioned air treatment element and air treatment unit according to the appended claims. These objectives are also achieved with the above-mentioned method, performed by a control device, for producing the air treatment element, a computer program and a computer-readable medium according to the appended claims.

According to an aspect of the invention, an air treatment element for an air treatment unit is provided. The air treatment element comprising: a drum shaped rotor element, provided with a rotational axis; a first end surface of the rotor element having a first normal, which is parallel to the rotational axis; a second end surface of the rotor element having a second normal, which is parallel to the rotational axis; and a plurality of channels, which are disposed parallel to the rotational axis, and which channels extend continuous from the first to the second end surface of the rotor element; wherein the air treatment element further comprises: at least one air treatment substance arranged on walls of the continuous channels, wherein the content of the at least one air treatment substance is arranged to increase or decrease in a direction from the first end surface to the second end surface.

According to a further aspect of the invention an air treatment unit is provided, wherein the air treatment unit comprises an air treatment element disclosed herein.

According to a further aspect of the invention a method, performed by a control device, for producing an air treatment element is provided. The method comprising the step of: controlling at least one nozzle for providing at least one air treatment substance to a substrate for the rotor element or for creating the rotor element.

According to an aspect of the invention, a computer program is provided, the computer program comprising instructions which, when the program is executed by a computer, cause the computer to carry out the method. Also, a computer-readable medium is provided, the computer-readable medium comprising instructions, which when executed by a computer, cause the computer to carry out the method. This has the advantage that the method may be comprised in pre-programmed software, which may be implemented into the production, suitable for utilizing the method.

An advantage of the invention is that the air treatment element allows for a stable, reliable and effective treatment of air, and thereby improves the functionality/performance of an air handling unit. A further advantage of the present invention is that the method for producing the air treatment element facilitates the production of air treatment elements having different characteristics. A further advantage of the present invention is that the method for producing an air treatment element allows the flexibility to alter the material properties in the treatment element. The method allows a more real-time adjustment of the application of the air treatment substances when creating the rotor element or the substrate for a rotor element.

Additional objectives, advantages and novel features of the invention will be apparent to one skilled in the art from the following details, and through exercising the invention. While the invention is described below, it should be apparent that the invention may not be limited to the specifically described details. One skilled in the art, having access to the teachings herein, will recognize additional applications, modifications and incorporations in other areas, which are within the scope of the invention.

### BRIEF DESCRIPTION OF THE DRAWINGS

For fuller understanding of the present disclosure and further objects and advantages of it, the detailed description set out below should be read together with the accompanying drawings, in which the same reference notations denote similar items in the various figures, and in which:

FIG. 1a schematically illustrates a side view of an air treatment unit according to an example;

FIG. 1b schematically illustrates a partial section view of an air treatment element according to an example;

FIG. 1c schematically illustrates a partial section view of an air treatment element according to an example;

FIG. 1d schematically illustrates a partial section view of an air treatment element according to an example;

FIG. 2a schematically illustrates a view from above of a production unit for producing an air treatment element according to an example;

FIG. 2b schematically illustrates a front view of the production unit in FIG. 2a;

FIG. 2c schematically illustrates a front view of the production unit in FIG. 2a according to an example;

FIG. 2d schematically illustrates a side view of the production unit in FIG. 2c;

FIG. 3 schematically illustrates a view in perspective of a 3D printer for producing an air treatment element according to an example;

FIG. 4 shows a flowchart of a method according to an example; and

FIG. 5 schematically illustrates a control device or computer according to an example.

### DETAILED DESCRIPTION

The detailed description with reference to the examples depicted are to be viewed as examples comprising a combination of certain features, which features have been described in detail above. It is thus to be understood that additional examples may be achieved by combining other features into examples not depicted herein. The figures are to be viewed as examples and not mutually exclusive combinations. It should also be noted that all FIGS. shown and described are schematically represented, wherein generic parts of machinery or similar is not depicted for the sake of simplicity.

According to an aspect of the present disclosure, an air treatment element for an air treatment unit is provided. The air treatment element comprising: a drum shaped rotor element, provided with a rotational axis; a first end surface of the rotor element having a first normal, which is parallel to the rotational axis; a second end surface of the rotor element having a second normal, which is parallel to the rotational axis; and a plurality of channels, which are disposed parallel to the rotational axis, and which channels extend continuous from the first to the second end surface of the rotor element; wherein the air treatment element further comprises: at least one air treatment substance arranged on walls of the continuous channels, wherein the content of the at least one air treatment substance is arranged to increase or decrease in a direction from the first end surface to the second end surface.

The air treatment element may be configured to treat air by reducing or removing water vapour, chemicals and/or particles from the air and/or to transfer heat. Air may contain water vapour. In some situations, it is preferred to reduce or remove the water vapour in the air. Air may contain different kind of chemicals, such as carbon dioxide or volatile organic compounds. In some situations, it is preferred to reduce or remove the chemicals in the air. Air may contain different kind of particles, and in some situations, it is preferred to reduce or remove the particles in the air. Air may be hot or cold. In some situations, it is preferred to reduce or increase the air temperature by direct heat exchange operation and/or by endothermic/exothermic sorption processes. The air treatment element may thus be configured to reduce or remove water vapour, chemicals and/or particles in the air and/or to change the heat content in the air.

The air treatment unit may comprise an air treatment element. The air treatment unit may also comprise inlet and outlet openings for air, such as process air and regenerative air. Further, the air treatment unit may comprise propulsion units, such as electrical motors for propulsion of fans, blowers air treatment elements and dampers. The air treatment unit may also comprise sensors and control equipment.

The drum shaped rotor element may be fabricated by a flat and a pleated material, such as a fibre material, which has been joint together to a laminate. The laminate is rolled into the shape of a rotor or stacked in blocks and thereafter machined to a rotor element. The rotor element can be said to resemble corrugated paperboard that has been rolled up to form a rotor, or corrugated board that has been cut into lengths and the lengths stacked together to form a block.

The first end surface of the rotor element has a first normal and the second end surface of the rotor element having a second normal. The first and second normal may be parallel to each other. The first and second normal may be directed in opposite directions to each other. The rotational axis passes through the first and second end surfaces. The rotational axis is parallel to the first and second normal. The rotational axis coincides with a rotational symmetry axis of the rotor element. The rotor element may have a radius and thickness adapted to the size and the performance of the air treatment unit. The thickness of the rotor element is the length between the first and second end surfaces in the direction of the rotational axis.

The rotor element includes a structure that has a plurality of mutually parallel channels. The channels are disposed parallel to the rotational axis. The channels extend continuous from the first to the second end surface. Thus, the channels are not interrupted by seams in their extension between the end surfaces. The end of the channels are opened at the first and second end surfaces. Thus, the first and second end surfaces of the rotor element comprises a large number of channel openings. A fan or blower of the air treatment unit is configured to creating an air flow through the channels by driving the air through the channels. Due to the continuous extension of the channels there will be no leakage or a minimal leakage of air between the channels in the rotor element.

Since the least one air treatment substance is arranged on walls of the continuous channels, and the content of the at least one air treatment substance is arranged to increase or decrease in a direction from the first end surface to the second end surface the functionality/performance of an air handling unit is improved. The air will be treated by the at least one air treatment substance when flowing in and through the channels in the rotor element. The air to be treated is called process air.

According to an aspect, the increase or decrease of the content of the at least one air treatment substance is a linearly increase or decrease. The intensity with which at least one air treatment substance will treat the air may vary linearly.

According to an aspect, the increase or decrease of the content of the at least one air treatment substance is a non-linear increase or decrease. The intensity with which the at least one air treatment substance will treat the air may vary non-linear, such as exponentially, parabolic or logarithmically.

The content of the at least one air treatment substance may increase or decrease linearly in a direction from the first end surface to the second end surface. However, in a part of the rotor element, the content of the at least one air treatment substance may increase or decrease non-linearly in a direction from the first end surface to the second end surface. Thus, there may be a combination of linearly and non-linearly increases and decreases of the content of the at least one air treatment substance in a direction from the first end surface to the second end surface of the rotor element.

According to an aspect, the at least one air treatment substance comprises a first air treatment substance and a second air treatment substance. The first and second air treatment substances are arranged on walls of the continuous channels. The expression “on walls” may also include that the first and second air treatment substances may be arranged in the walls of the continuous channels. A rotor element may be made of a material having a porosity that may allow the first and second air treatment substances to penetrate into the walls of the continuous channels. The rotor element may be made of the first and second air treatment substances. The rotor element may be made of a load-bearing material, which is mixed with the first and second air treatment substances.

The first air treatment substance may be configured to reduce or remove water vapour, chemicals and/or particles from the air. The second air treatment substance may be configured to reduce or remove water vapour, chemicals and/or particles from the air.

Since the walls of the channels include the first and second air treatment substances, the air will be treated by the first and second air treatment substances when flowing in and through the channels in the rotor element. The air to be treated is called process air. Another air flow may pass through a minor sector in the rotor element and expels any removed moisture, chemicals and/or particles from the rotor element. This airflow is called reactivation air. The reactivation air may be heated before enter the channels in the rotor element. The reactivation air may contain additives for removing moisture, chemicals and/or particles from the rotor element. Thus, treated air is produced continuously, by continually rotating the rotor element between the sector containing process air to be treated and the sector through which the reactivation air passes. Further, an additional sector may be arranged through which purge air passes. The moisture, chemicals and/or particles extracted from the rotor element is carried away with the reactivation air flow and the purge airflow in a separate passage system.

The increase or decrease of the content of the first and second air treatment substance may be a linearly increase or decrease. The intensity with which the first and second air treatment substances will treat the air may vary linearly. Alternatively, the increase or decrease of the content of the first and second air treatment substance may be a non-linear increase or decrease. The intensity with which the first and second air treatment substances will treat the air may vary non-linear, such as exponentially, parabolic or logarithmically. One of the first and second air treatment substance may vary non-linear and the other air treatment substance may vary linearly.

According to an aspect, the first air treatment substance is a first desiccant material, configured for attracting and retaining water vapour from the air; and the second air treatment substance is a second desiccant material, different from the first desiccant material. The first and second desiccant materials may have different attraction characteristics for separating and removing moisture and water vapour from air. The attraction characteristics of the first and second desiccant materials may be dependent on different values of the relative humidity in the air and different temperatures of the air. The substance configured for attracting and retaining moisture may be silica gel, colloidal silica, lithium chloride, calcium chloride, hygroscopic salts, zeolites, activated carbon, hydrophilic organic polymers, molecular organic frameworks, metal oxides and/or metal dioxides, hydroxides, carbonates, catalysts or covalent organic frameworks.

According to an aspect, the first air treatment substance is a first desiccant material, configured for attracting and retaining water vapour from the air; and the second air treatment substance is configured for attracting and retaining a carbon dioxide substance, configured for reducing carbon dioxide from the air. The air surrounding the air treatment unit may comprise a mixture of water vapour and carbon dioxide. The first desiccant material is configured for attracting and retaining the water vapour from the air. The carbon dioxide reducing substance is configured for reducing carbon dioxide from the air. The substance configured for attracting and retaining carbon dioxide may be_zeolites, amines, amine functionalized compounds, activated carbon, molecular organic frameworks, metal oxides and/or metal dioxides, hydroxides, carbonates, silica, catalysts or covalent organic frameworks.

According to an aspect, the first air treatment substance is configured for attracting and retaining volatile organic compounds from the air; and the second air treatment substance is different from the first air treatment substance. The substances configured for attracting and retaining volatile organic compounds may be_zeolites, activated carbon, molecular organic frameworks, metal oxides and/or metal dioxides, silica, catalysts or covalent organic frameworks. The first air treatment substance may be a first zeolite, configured for attracting and retaining volatile organic compounds from the air; and the second air treatment substance may be a second zeolite, different from the first zeolite. The first and second zeolites may have different characteristics for attracting and retaining volatile organic compounds from the air. The attracting and retaining characteristics of the first and second zeolites may be dependent on different values of the intensity of the volatile organic compounds the air and/or be configured to attract and retain different types of volatile organic compounds.

According to an aspect, the first air treatment substance is arranged in a first section of the rotor element, which first section extends from the first end surface to a first plane in the rotor element having a third normal parallel to the rotational axis, and wherein the second air treatment substance is arranged in a second section of the rotor element, which second section extends from the first plane to the second end surface. The first plane may be an imaginary plane, which acts as border between the first and second sections. The air to be treated may enter the rotor element at the first end surface and thus first be treated by the first air treatment substance. When the air is reaching the first plane and enter the second section, the air will be treated by the second air treatment substance. The air to be treated may alternatively flow in the opposite direction through the channels in the rotor element and thus first be treated by the second air treatment substance and thereafter by the first air treatment substance.

According to an aspect, a third section of the rotor element extends from the first plane to a second plane in the rotor element having a fourth normal parallel to the rotational axis, wherein the second plane is arranged between the first plane and the second end surface, and wherein the content of the first air treatment substance is arranged to decrease in a direction from the first plane to the second plane, and the content of the second air treatment substance is arranged to increase in a direction from the first plane to the second plane. The second plane may be an imaginary plane, which acts as border between the third and second sections. The air to be treated may enter the rotor element at the first end surface and thus first be treated solely by the first air treatment substance. When the air is reaching the first plane and enter the third section, both the first and second air treatment substances will together treat the air, but with different intensity. The intensity of the first air treatment substance will decrease and the intensity of the second air treatment substance will increase. When the air is reaching the second plane and enter the second section, the air may be treated solely by the second air treatment substance. The air to be treated may alternatively flow in the opposite direction through the channels in the rotor element and thus first be solely treated by the second air treatment, be treated by the both the first and second air treatment substances together and thereafter be solely treated by the first air treatment substance. Above, three sections and two internal planes in the rotor are discussed. However, it may be possible to arrange more than three sections and more than two internal planes in the rotor.

According to an aspect, the content of the first air treatment substance is arranged to decrease in a direction from the first end surface to the second end surface, and the second air treatment substance is arranged to increase in a direction from the first end surface to the second end surface. When the air to be treated is reaching the first end surface and enter the channels in the rotor element, both the first and second air treatment substances will together treat the air, but with different intensity. The intensity of the first air treatment substance will decrease and the intensity of the second air treatment substance will increase.

According to an aspect, the content of the first air treatment substance is arranged to increase in a direction from the first end surface to the second end surface, and the second air treatment substance is arranged to decrease in a direction from the first end surface to the second end surface. When the air to be treated is reaching the first end surface and enter the channels in the rotor element, both the first and second air treatment substances will together treat the air, but with different intensity. The intensity of the second air treatment substance will decrease and the intensity of the first air treatment substance will increase.

According to a further aspect of the present disclosure, the air treatment unit may comprise the air treatment element disclosed herein. The air treatment unit may comprise inlet and outlet openings for air, such as process air and regenerative air. Further, the air treatment unit may comprise propulsion units, such as electrical motors for propulsion of fans, blowers, air treatment elements and dampers. The air treatment unit may also comprise sensors and control equipment. The inlet and outlet openings may be arranged in a housing, which accommodating the air treatment element. The fans and blowers may be driven by electrical motors arranged outside or in the housing of the air treatment unit. The fans and blowers generate a flow of the process air and the regenerative air. The air treatment unit may comprise a heater for increasing the temperature of the regenerative air. The dampers may be configured to regulate the airflow through the air treatment element. The sensors may provide the control equipment with information about temperature, flowrate, relative humidity and other characteristics in order to control the air treatment unit. The air treatment unit may comprise at least one air treatment element disclosed herein. Two air treatment elements may be stacked on each other in an air treatment unit. More than two air treatment elements may be stacked on each other in an air treatment unit.

The at least one nozzle for providing the at least one air treatment substance may be controlled for providing different flow rates at different positions in order to generate composition gradients of air treatment substances.

According to a further aspect of the present disclosure, a method, performed by a control device, for producing an air treatment element for an air treatment unit is provided. The air treatment element comprising: a drum shaped rotor element, provided with a rotational axis; a first end surface of the rotor element having a first normal, which is parallel to the rotational axis; a second end surface of the rotor element having a second normal, which is parallel to the rotational axis; and a plurality of channels, which are disposed parallel to the rotational axis, and which channels extend continuous from the first to the second end surface of the rotor element; wherein the method comprising the step of: controlling at least one nozzle for providing at least one air treatment substance to a substrate for the rotor element or for creating the rotor element.

According to an aspect, the step of controlling at least one nozzle for providing at least one air treatment substance to a substrate for the rotor element or for creating the rotor element comprising the steps of: controlling a first nozzle for providing a first air treatment substance; controlling a second nozzle for providing a second air treatment substance; and controlling the position of the first and second nozzles for creating the rotor element comprising the first and second air treatment substance or for applying the first and second air treatment substance on the substrate for the rotor element.

The air treatment element comprising the drum shaped rotor element, provided with a rotational axis. The first end surface of the rotor element having a first normal, which is parallel to the rotational axis. The second end surface of the rotor element having a second normal, which is parallel to the rotational axis. A plurality of channels are disposed parallel to the rotational axis, and which channels extend continuous from the first to the second end surface of the rotor element. The air treatment element further comprises the first air treatment substance arranged on walls of the continuous channels, and the second air treatment substance arranged on the walls of the continuous channels.

The method step of controlling the first nozzle for providing the first air treatment substance may comprise controlling the movement of the first nozzle for providing the first air treatment substance at a specific position. Controlling the first nozzle may comprise activating and deactivating the first nozzle for providing the first air treatment substance. The first nozzle may be configured to provide the first air treatment substance in a liquid and/or solid state.

The method step of controlling the second nozzle for providing the second air treatment substance may comprise controlling the movement of the second nozzle for providing the first second air treatment substance at a specific position. Controlling the second nozzle may comprise activating and deactivating the second nozzle for providing the second air treatment substance. The second nozzle may be configured to provide the second air treatment substance in a liquid and/or solid state.

The method step of controlling the position of the first and second nozzles for creating a rotor element comprising the first and second air treatment substance or for applying the first and second air treatment substance on the substrate for the rotor element may result in a finished rotor element or in a substrate from which the rotor element is finished. The substrate may emanate from a pleated material, which is coated with the first and second air treatment substances. The substrate may alternatively be produced of the first and second air treatment substances. The substrate may alternatively be produced of the first and second air treatment substances together with a load-bearing material. The control device is configured to perform the method.

According to an aspect, controlling at least one nozzle for providing at least one air treatment substance to a substrate for the rotor element or for creating the rotor element, comprises spraying the at least one air treatment substances on the substrate for the rotor element. The at least one air treatment substance may be provided in liquid or powder form on the substrate. When spraying the at least one air treatment substances on the substrate for the rotor element, the at least one nozzle may be a spray nozzle.

According to an aspect, controlling at least one nozzle for providing at least one air treatment substance to a substrate for the rotor element or for creating the rotor element, comprises feeding the at least one air treatment substance together with a first and second 3D-printing material. The at least one nozzle may be a component in a 3D printer. Thus, the rotor element and/or the substrate may be printed in three dimensions in the 3D printer. The 3D-printing material may be a load-bearing material mixed with the at least one air treatment substance.

According to an aspect, controlling the position of the first and second nozzles for creating the rotor element comprising the first and second air treatment substance or for applying the first and second air treatment substance on the substrate for the rotor element, comprises controlling the position of the first and second nozzles for creating the rotor element in a direction of the rotational axis of the rotor element. The rotor element may be created on a platform or on a table in a 3D printer. The first and second nozzles are controlled so that the rotor element is build up in the direction of the rotational axis.

The at least one nozzle may be fed with different air treatment substances or different mixtures of said air treatment substances depending on the spraying position on the rotor element.

The present disclosure also relates to a computer program comprising instructions which, when the program is executed by a computer, causes the computer to carry out the method disclosed above. The invention further relates to a computer-readable medium comprising instructions, which when executed by a computer causes the computer to carry out the method disclosed above. The method may be comprised in pre-programmed software, which may be implemented into a production unit suitable for utilizing the method. The pre-programmed software may be stored in the control device. Alternatively, or in combination, the software may be stored in a memory or in computer at a distance from the control device. The air treatment element, the air treatment unit, the method, the computer program and the computer-readable medium will now be described together with the appended drawings.

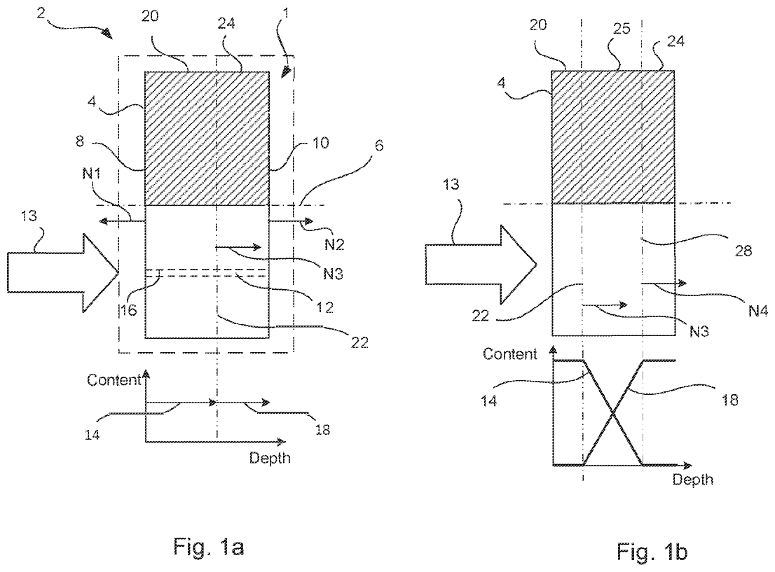

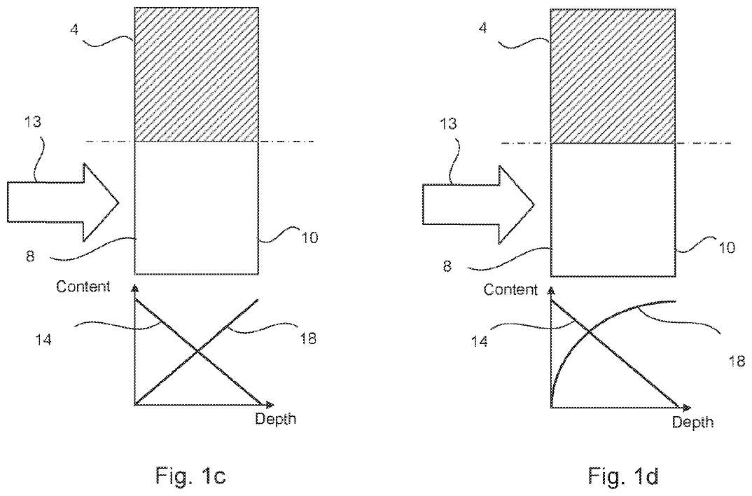

FIG. 1a schematically illustrates a side view of an air treatment unit according to an example. The air treatment unit is schematically disclosed with broken lines. An air treatment element 1 is arranged in the air treatment unit 2. The air treatment element 1 is disclosed in a partly section view. The air treatment element 1 comprising a drum shaped rotor element 4, provided with a rotational axis 6. A first end surface 8 of the rotor element 4 has a first normal N1, which is parallel to the rotational axis 6. A second end surface 10 of the rotor element 4 has a second normal N2, which is parallel to the rotational axis 6. A plurality of channels 12 are disposed parallel to the rotational axis 6, and which channels 12 extend continuous from the first to the second end surface 8, 10 of the rotor element 4. A process air flow 13 is indicated with an arrow. A first air treatment substance 14 is arranged on walls 16 of the continuous channels 12. A second air treatment substance 18 is arranged on the walls 16 of the continuous channels 12. The first air treatment substance 14 is arranged in a first section 20 of the rotor element 4. The first section 20 extends from the first end surface 8 to a first plane 22 in the rotor element 4 having a third normal N3 parallel to the rotational axis 6. The second air treatment substance 18 is arranged in a second section 24 of the rotor element 4, which second section 24 extends from the first plane 22 to the second end surface 10.

FIG. 1b schematically illustrates a partial section view of an air treatment element according to an example. A third section of the rotor element 4 extends from the first plane 22 to a second plane 28 in the rotor element 4 having a fourth normal N4 parallel to the rotational axis 6. The second plane 28 is arranged between the first plane 22 and the second end surface 10. The content of the first air treatment substance 14 is arranged to decrease in a direction from the first plane 22 to the second plane 28, and the content of the second air treatment substance 18 is arranged to increase in a direction from the first plane 22 to the second plane 28.

FIG. 1c schematically illustrates a partial section view of an air treatment element according to an example. The content of the first air treatment substance 14 is arranged to decrease in a direction from the first end surface 8 to the second end surface 10. The second air treatment substance 18 is arranged to increase in a direction from the first end surface 8 to the second end surface 10. Alternatively, the content of the first air treatment substance 14 may be arranged to increase in a direction from the first end surface 8 to the second end surface 10, and the second air treatment substance 18 may be arranged to decrease in a direction from the first end surface to the second end surface 10. The increase or decrease of the content of the first and second air treatment substance 14, 18 is a linearly increase or decrease. FIG. 1d schematically illustrates a partial section view of an air treatment element 4 according to an example. The increase or decrease of the content of the first and/or second air treatment substance 14, 18 is a non-linear increase or decrease.

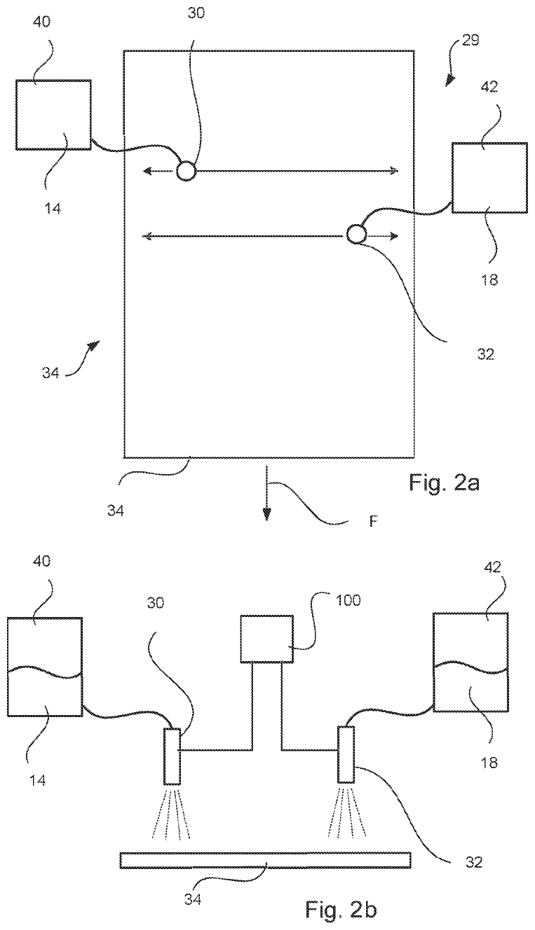

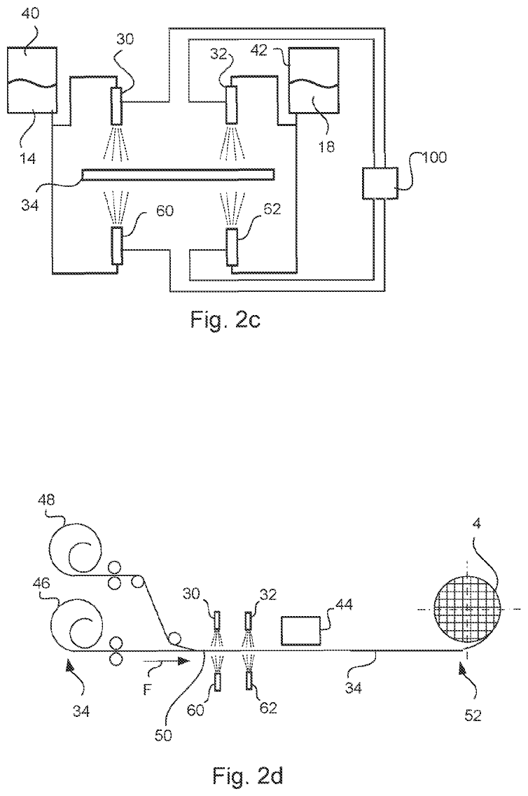

FIG. 2a schematically illustrates a view from above of a production unit 29 for producing an air treatment element 2 according to an example. FIG. 2b schematically illustrates a front view of the production unit in FIG. 2a. FIG. 2c schematically illustrates a front view of the production unit in FIG. 2a according to an example. FIG. 2d schematically illustrates a side view of the production unit in FIG. 2c. According to FIGS. 2a and b, a first nozzle 30 is controlled by a control device 100 for providing the first air treatment substance 14. A second nozzle 32 is controlled by the control device for providing the second air treatment substance 18. Alternatively, only one nozzle 30, 32 is used. Alternatively, more than two nozzles 30, 32 are used. The position of the first and second nozzles 30, 32 are controlled for creating the rotor element 4 or a substrate 34 for the rotor element 4. The first and second nozzles 30, 32 may be movable in a traverse direction in relation to a feeding direction F of the substrate 34. Alternatively, the position of the first and second nozzles 30, 32 may be fixed. Containers 40, 42 with the first and second treatment substances 14, 18 are connected to the nozzles. The first and second treatment substances 14, 18 may be applied at different flow rates at different positions on the substrate 34. In addition, each container 40, 42 may contain a mixture of the first and second treatment substances 14, 18. In FIG. 2b the first and second nozzle 30, 32 are configured to spray the first and second air treatment substances 14, 18 on a first side the substrate 34. In FIG. 2c, third and fourth nozzles 60, 62 are arranged below the substrate 34. The third and fourth nozzles 60, 62 are configured to spray the first and second air treatment substances 14, 18 on a second side of the substrate 34. In the production unit shown in FIG. 2d, a rotor element 4 is produced by a laminate 50. The substrate 34 may comprise a pleated material 46, which is connected to a flat material 48 to the laminate 50. The material may be fibre material, such as paper. The first and second nozzles 30, 32 are configured to spray the first and second air treatment substances 14, 18 on the first side the laminate 50. The third and fourth nozzles 60, 62 are configured to spray the first and second air treatment substances 14, 18 on a second side of the laminate 50. The air treatment substances 14,16 may penetrate the pleated material 46 and the flat material 48 of the substrate 50, so that the air treatment substances 14, 18 is arranged on the walls of the channels 12 in the laminate 50. The air treatment substances 14,16 may as an alternative be applied onto the substrate 50 before lamination. A dryer 44 may be arranged for drying the laminate 50 after the first and second treatment substances 14, 18 have been applied on the laminate 50. The laminate 50 is rolled up to a rotor element 4 in a roll-up station 52.

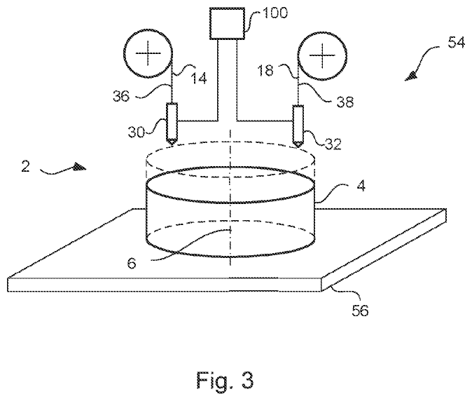

FIG. 3 schematically illustrates a view in perspective of a 3D printer 54 for producing an air treatment element 2 according to an example. The first and second nozzles 30, 32 feeds the first and second air treatment substance 14, 18 together with a first and second 3D-printing material 36, 38. The first and second nozzles are in FIG. 3 components in the 3D printer 54. Thus, the rotor element 4 and/or the substrate 34 may be printed in three dimensions in the 3D printer 54. The first and second 3D-printing material 36, 38 may be a load-bearing material mixed with the first and second air treatment substances 14, 18. The position of the first and second nozzles 30, 32 are controlled by the control device 100 for creating the rotor element 4 in a direction of the rotational axis 6 of the rotor element 4. The rotor element may be created on a platform 56 or on a table in a 3D printer 54. The first and second nozzles 30, 32 are controlled so that the rotor element 6 is build up in the direction of the rotational axis 6., i.e. in the vertical direction from a first end surface 8 to a second end surface 10 in FIG. 3. The content of the first air treatment substance 14 may be arranged to decrease in a direction from the first end surface 8 to the second end surface 10, and the second air treatment substance 18 may be arranged to increase in a direction from the first end surface 8 to the second end surface 10. Alternatively, the content of the first air treatment substance 14 may be arranged to increase in a direction from the first end surface 8 to the second end surface 10, and the second air treatment substance 18 may be arranged to decrease in a direction from the first end surface 8 to the second end surface 10.

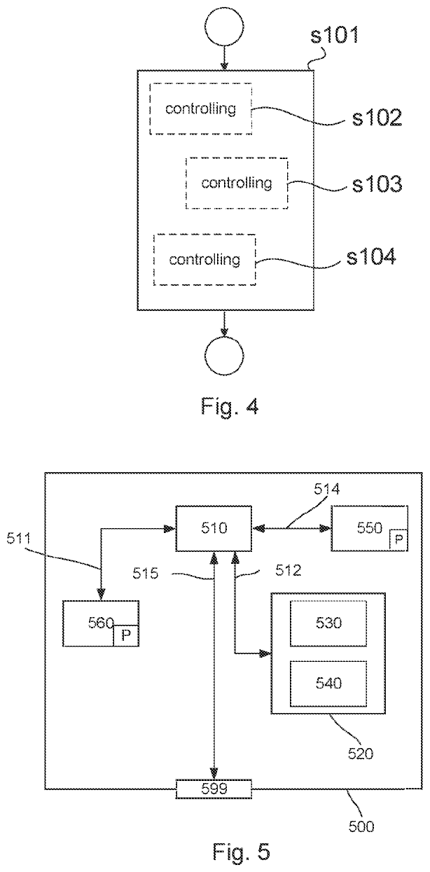

FIG. 4 shows a flowchart of a method according to an example. The method is performed by a control device 100, for producing an air treatment element. The method relates to the air treatment element disclosed in FIGS. 1-3. The air treatment element thus comprises a drum shaped rotor element, provided with a rotational axis; a first end surface of the rotor element having a first normal, which is parallel to the rotational axis; a second end surface of the rotor element having a second normal, which is parallel to the rotational axis; and a plurality of channels, which are disposed parallel to the rotational axis, and which channels extend continuous from the first to the second end surface of the rotor element; wherein the air treatment element further comprises: a first air treatment substance arranged on walls of the continuous channels; and a second air treatment substance arranged on the walls of the continuous channels. The method comprising the steps of: controlling S101 a first nozzle 30 for providing a first air treatment substance 14; controlling s102 a second nozzle 32 for providing a second air treatment substance 18; and controlling s103 the position of the first and second nozzles 30, 32 for creating a rotor element 4 or a substrate 34 for a rotor element 4 comprising the first and second air treatment substance 14, 18.

FIG. 5 schematically illustrates a diagram of a version of a device 500. The control device 100 described with reference to FIGS. 2-3 may in a version comprise the device 500. The device 500 comprises a non-volatile memory 520, a data processing unit 510 and a read/write memory 550. The non-volatile memory 520 has a first memory element 530 in which a computer programme, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

There is provided a computer programme P which comprises instructions for carry out the above-mentioned method. The programme P may be stored in an executable form or in a compressed form in a memory 560 and/or in a read/write memory 550.

Where the data processing unit 510 is described as performing a certain function, it means that the data processing unit 510 effects a certain part of the programme stored in the memory 560 or a certain part of the programme stored in the read/write memory 550. The data processing device 510 can communicate with a data port 599 via a data bus 515. The non-volatile memory 520 is intended for communication with the data processing unit 510 via a data bus 512. The separate memory 560 is intended to communicate with the data processing unit 510 via a data bus 511. The read/write memory 550 is adapted to communicating with the data processing unit 510 via a data bus 514.

When data are received on the data port 599, they are stored temporarily in the second memory element 540. When input data received have been temporarily stored, the data processing unit 510 is prepared to effect code execution as described above.

Parts of the methods herein described may be effected by the device 500 by means of the data processing unit 510 which runs the programme stored in the memory 560 or the read/write memory 550. When the device 500 runs the programme, methods herein described are executed.

The foregoing description of the embodiments has been furnished for illustrative and descriptive purposes. It is not intended to be exhaustive, or to limit the embodiments to the variations described. Many modifications and variations will obviously be apparent to one skilled in the art. The embodiments have been chosen and described in order to best explicate principles and practical applications, and to thereby enable one skilled in the arts to understand the invention in terms of its various embodiments and with the various modifications that are applicable to its intended use. The components and features specified above may, within the frame work of the disclosure, be combined between different embodiments specified.

1. An air treatment element for an air treatment unit, the air treatment element comprising:
a drum shaped rotor element, provided with a rotational axis;
a first end surface of the rotor element having a first normal, which is parallel to the rotational axis;
a second end surface of the rotor element having a second normal, which is parallel to the rotational axis; and
a plurality of channels, which are disposed parallel to the rotational axis, and which channels extend continuous from the first end surface to the second end surface of the rotor element; and
at least one air treatment substance arranged on walls of the continuous channels, wherein the content of the at least one air treatment substance is arranged to increase or decrease in a direction from the first end surface to the second end surface.

2. The air treatment element of claim 1, wherein the increase or decrease of the content of the at least one air treatment substance is a linearly increase or decrease.

3. The air treatment element of claim 1, wherein the increase or decrease of the content of the at least one air treatment substance is a non-linear increase or decrease.

4. The air treatment element of claim 1, wherein the at least one air treatment substance comprises:
a first air treatment substance and a second air treatment substance.

5. The air treatment element of claim 4, wherein the first air treatment substance is a first desiccant material, configured for attracting and retaining water vapor from the air; and the second air treatment substance is a second desiccant material, different from the first desiccant material.

6. The air treatment element of claim 4, wherein the first air treatment substance is a first desiccant material, configured for attracting and retaining water vapor from the air; and the second air treatment substance is a substance, configured for attracting and retaining carbon dioxide from the air.

7. The air treatment element of claim 4, wherein the first air treatment substance is configured for attracting and retaining volatile organic compounds from the air; and the second air treatment substance is different from the first air treatment substance.

8. The air treatment element of claim 4, wherein the first air treatment substance is arranged in a first section of the rotor element, which first section extends from the first end surface to a first plane in the rotor element having a third normal parallel to the rotational axis, and wherein the second air treatment substance is arranged in a second section of the rotor element, which second section extends from the first plane to the second end surface.

9. The air treatment element of claim 8, wherein a third section of the rotor element extends from the first plane to a second plane in the rotor element having a fourth normal parallel to the rotational axis, wherein the second plane is arranged between the first plane and the second end surface, and wherein the content of the first air treatment substance is arranged to decrease in a direction from the first plane to the second plane, and the content of the second air treatment substance is arranged to increase in a direction from the first plane to the second plane.

10. The air treatment element of claim 4, wherein the content of the first air treatment substance is arranged to decrease in a direction from the first end surface to the second end surface, and the second air treatment substance is arranged to increase in a direction from the first end surface to the second end surface.

11. The air treatment element of claim 4, wherein the content of the first air treatment substance is arranged to increase in a direction from the first end surface to the second end surface, and the second air treatment substance is arranged to decrease in a direction from the first end surface to the second end surface.

12. An air treatment unit, wherein the air treatment unit comprises at least one air treatment element according to claim 1.

13. A method, performed by a control device, for producing an air treatment element for an air treatment unit, the air treatment element comprising:
a drum shaped rotor element, provided with a rotational axis;
a first end surface of the rotor element having a first normal, which is parallel to the rotational axis;
a second end surface of the rotor element having a second normal, which is parallel to the rotational axis; and
a plurality of channels, which are disposed parallel to the rotational axis, and which channels extend continuous from the first to the second end surface of the rotor element, the method comprising the step of:
controlling at least one nozzle for providing at least one air treatment substance to a substrate for the rotor element or for creating the rotor element.

14. The method according to claim 13, wherein the step of controlling at least one nozzle for providing at least one air treatment substance to a substrate for the rotor element or for creating the rotor element comprises the steps of:
controlling a first nozzle for providing a first air treatment substance;
controlling a second nozzle for providing a second air treatment substance; and
controlling the position of the first and second nozzles for creating the rotor element comprising the first and second air treatment substances or for applying the first and second air treatment substances on the substrate for the rotor element.

15. The method according to claim 13, wherein controlling at least one nozzle for providing at least one air treatment substance to a substrate for the rotor element or for creating the rotor element, comprises spraying the at least one air treatment substance on the substrate for the rotor element.

16. The method according to claim 13, wherein controlling at least one nozzle for providing at least one air treatment substance to a substrate for the rotor element or for creating the rotor element, comprises feeding the at least one air treatment substance together with first and second 3D-printing materials.

17. The method according to claim 14, wherein controlling the position of the first and second nozzles for creating the rotor element comprising the first and second air treatment substances or for applying the first and second air treatment substances on the substrate for the rotor element, comprises controlling the position of the first and second nozzles for creating the rotor element in a direction of the rotational axis of the rotor element.

18. A computer program stored on a non-transitory computer-readable medium and comprising instructions which, when the program is executed by a computer, cause the computer to carry out the method according to claim 13.

19. A non-transitory computer-readable medium comprising instructions, which when executed by a computer, cause the computer to carry out the method according to claim 13.
